(19) United States
(12) Patent Application Publication
(10) Pub. No.: US 2025/0117284 A1
(43) Pub. Date: Apr. 10, 2025

(54) LOW-DENSITY PARITY CHECK DECODER

(71) Applicant: Cortina Access, Inc., San Jose, CA (US)

(72) Inventor: Sebastian Havluj ZIESLER, San Jose, CA (US)

(21) Appl. No.: 18/664,740

(22) Filed: May 15, 2024

Related U.S. Application Data
(60) Provisional application No. 63/542,311, filed on Oct. 4, 2023.

(51) Int. Cl. G06F 11/10

(52) U.S. Cl. CPC G06F 11/1004

(57) ABSTRACT

An LDPC decoder includes a parity check code storage block, a computing circuit, and a multiplexing circuit. The parity check code storage block is configured to store a parity check code matrix The parity check code matrix includes a plurality of columns. Each of the columns includes a plurality of submatrices. Each of the submatrices includes a plurality of bits. The parity check code storage block includes a plurality of column group storage blocks. Each of the column group storage blocks is configured to store a column group including one or more of the columns. The computing circuit is directly connected to the parity check code storage block. The multiplexing circuit is coupled between the parity check code storage block and the computing circuit.

### CROSS-REFERENCE TO RELATED APPLICATION

This non-provisional application claims priority under 35 U.S.C. § 119 (e) to U.S. Provisional Application 63/542,311 filed on Oct. 4, 2023, the entire contents of which are hereby incorporated by reference.

### BACKGROUND OF THE INVENTION

### Technical Field

The present invention relates to a low-density parity check decoder which reduces clock speed and/or power consumption.

### Related Art

Low density parity check (LDPC) codes are widely used as error correction codes for passive optical networks (PON), Ethernet and other data communication protocols because the error correction capabilities of LDPC codes are very close to the theoretical maximum (i.e., Shannon Limit). A common algorithm used to perform decoding and error correction of LDPC codes is the log-likelihood ratio (LLR) minimum-sum algorithm.

A common hardware implementation for performing decoding and error correction of LDPC codes involves utilizing a plurality of minimum-sum computing engines to perform LLR minimum sum computations on the LDPC codes. In practice, two sets of multiplexing circuits containing a plurality of multiplexers are disposed between the storage block of the LDPC codes and the plurality of minimum-sum computing engines, so that the two sets of multiplexing circuits can multiplex the data contained in the LDPC codes and reverse-multiplex a plurality of computing results of the plurality of minimum-sum computing engines. Taking a 25G PON as an example, the LDPC codes of the 25G PON is a 17664×3072 sparse matrix composed of a 69×12 array of 256×256 submatrices. In order to decode and correct the data of one of the rows of the array of the submatrices in each clock cycle, the total computing time of the plurality of minimum-sum computing engines for decoding and error-correcting the LDPC codes is based on the number of the rows of the array of the submatrices, which is 12 clock cycles. In order to complete the decoding and error-correcting of the LDPC codes within 12 clock cycles, two sets of multiplexing circuits comprising a plurality of 12-to-1 multiplexers are disposed between the storage block of the LDPC codes of the 25G PON and the plurality of minimum-sum computing engines, so that the two set of multiplexing circuits can multiplex the data contained in the LDPC codes and reverse-multiplex a plurality of computing results of the plurality of minimum-sum computing engines.

However, since any one of the two sets of multiplexing circuits will affect the overall timing of the computations of the plurality of minimum-sum computing engines, using two sets of multiplexing circuits will increase the delay of the circuit configured to implement decoding, thereby limiting the clock speed of the circuit configured to implement decoding. Moreover, using two sets of multiplexing circuits will also increase the power consumption and circuit area of the circuit configured to implement decoding.

### SUMMARY OF THE INVENTION

In some embodiments, an LDPC decoder comprises a parity check code storage block, a computing circuit and a multiplexing circuit. The parity check code storage block is configured to store a parity check code matrix The parity check code matrix comprises a plurality of columns. Each of the columns comprises a plurality of submatrices. Each of the submatrices comprises a plurality of bits The parity check code storage block comprises a plurality of column group storage blocks. Each of the column group storage blocks is configured to store a column group comprising at least one of the columns. The computing circuit is directly connected to the parity check code storage block through a wire. The multiplexing circuit is coupled between the parity check code storage block and the computing circuit.

In some embodiments, the computing circuit comprises a plurality of computing engines. The multiplexing circuit comprises a plurality of multiplexers. The bits comprised in the submatrices are transmitted to the computing engines through the wire. The computing engines are configured to perform computations on the bits to obtain a plurality of computing results. The multiplexers are configured to multiplex the computing results and transmit the computing results to the parity check code storage block.

In some embodiments, the computing circuit comprises a plurality of computing engines. The multiplexing circuit comprises a plurality of multiplexers. The multiplexers are configured to multiplex the bits comprised in the submatrices and transmit the bits to the computing engines. The computing engines are configured to perform computations on the bits to obtain a plurality of computing results. The computing results are transmitted to the parity check code storage block through the wire.

In some embodiments, the LDPC decoder is a 25G passive optical network (PON) decoder.

In some embodiments, the number of the computing engines is 256.

In some embodiments, the multiplexers are all 12-to-1 multiplexers.

In some embodiments, each of the column group storage blocks comprises 6 precision bits.

In some embodiments, the 6 precision bits comprise 1 sign bit and 5 value bits.

In some embodiments, the number of the column group storage blocks is 24.

In some embodiments, the number of the columns comprised in each of the column groups ranges from 1 to 4.

In some embodiments, each of the columns is assigned to only one of the column group.

In some embodiments, each of the columns comprises a plurality of rows. Each of the submatrices is located in a corresponding one of the rows. Each of the submatrices is a zero matrix or a shifted identity matrix. The zero matrices located in the same row of all of the columns in each of the column groups are merged.

The following will describe the detailed features and advantages of the instant disclosure in detail in the detailed description. The content of the description is sufficient for any person skilled in the art to comprehend the technical context of the instant disclosure and to implement it accordingly. According to the content, claims and drawings disclosed in the instant specification, any person skilled in the art can readily understand the goals and advantages of the instant disclosure.

### BRIEF DESCRIPTION OF THE DRAWINGS

The disclosure will become more fully understood from the detailed description given herein below for illustration only, and thus not limitative of the disclosure, wherein:

FIG. 1A to FIG. 1C illustrate schematic views of an embodiment of a parity check code matrix.

FIG. 2 illustrates a schematic view of an embodiment of a plurality of column groups.

FIG. 3 illustrates another schematic view of the embodiment of the plurality of column groups.

FIG. 4 illustrates a flowchart of an embodiment of a method for grouping a plurality of columns of the parity check code matrix into the column groups.

FIG. 5 illustrates a flowchart of another embodiment of the method for grouping the columns of the parity check code matrix into the column groups.

FIG. 6 illustrates a schematic view of an embodiment of a parity check code storage block.

FIG. 7 illustrates a schematic view of an embodiment of an LDPC decoder.

FIG. 8A illustrates another schematic view of the embodiment of the LDPC decoder.

FIG. 8B illustrates a schematic view of another embodiment of the LDPC decoder.

FIG. 9A illustrates an enlarged view of an embodiment of a plurality of computing engines in area A1 of FIG. 8A.

FIG. 9B illustrates an enlarged view of an embodiment of the computing engines in area A2 of FIG. 8A.

FIG. 10 illustrates an enlarged view of another embodiment of the computing engines in area A1 of FIG. 8A.

FIG. 11 illustrates a schematic view of another embodiment of an LDPC decoder.

FIG. 12 illustrates a schematic view of an embodiment of a plurality of bits being transmitted to a plurality of computing engines.

FIG. 13 illustrates a schematic view of an embodiment of a plurality of multiplexers multiplexing a plurality of computing results and transmitting the plurality of computing results to the parity check code storage block.

### DETAILED DESCRIPTION OF THE INVENTION

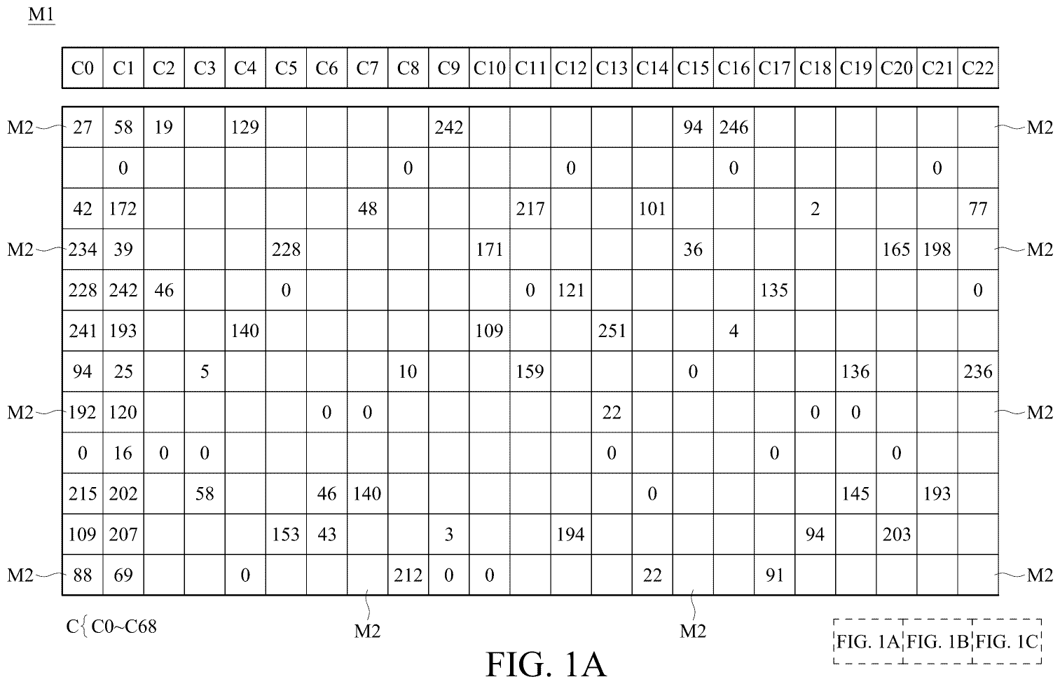

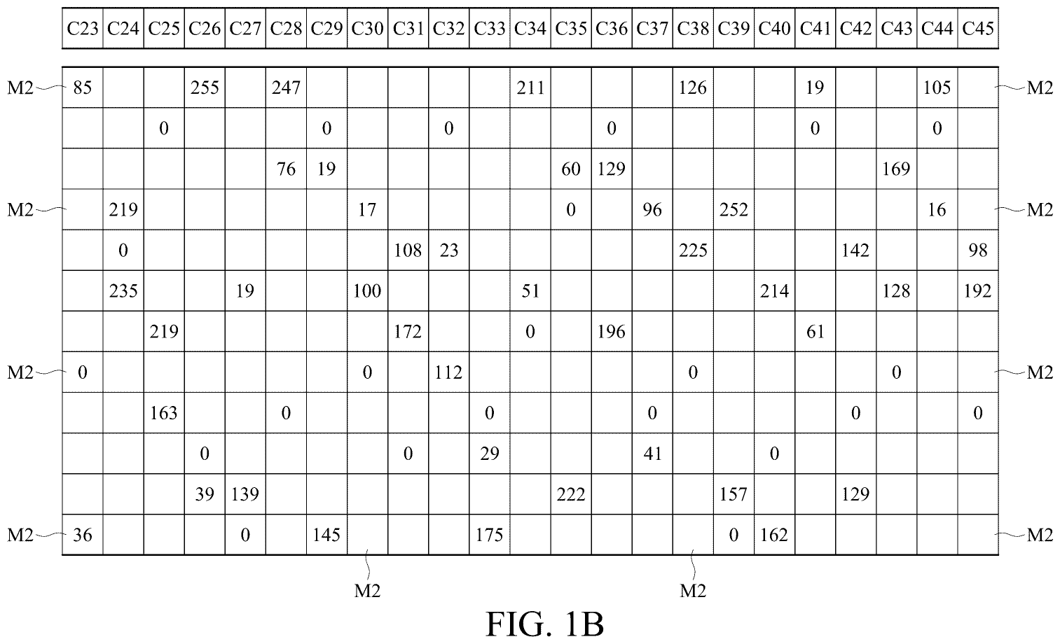

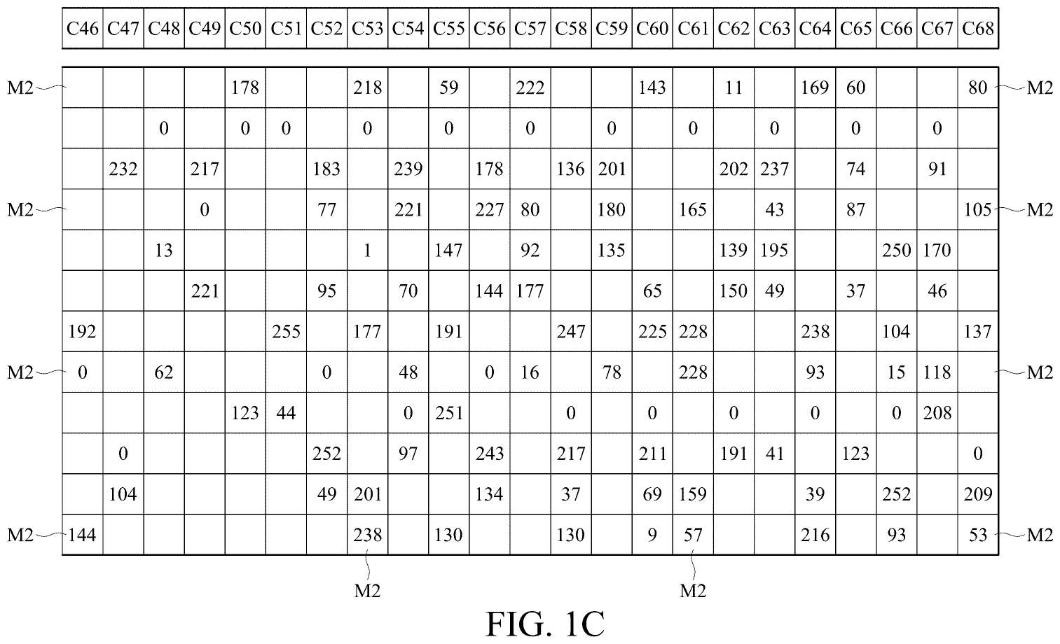

Please refer to FIG. 1A to FIG. 1C. A parity check code matrix M1 comprises a plurality of columns C, and each of the columns C comprises a plurality of submatrices M2. The parity check code matrix M1 shown in FIG. 1A to FIG. 1C is an LDPC check code adapted to a 25G PON which is a 17664×3072 sparse matrix composed of a 69×12 array of 256×256 submatrices, that is, this parity check code matrix M1 comprises sixty-nine columns C, and each of the columns C comprises twelve 256×256 submatrices M2. Each of the submatrices M2 is a zero matrix or a shifted identity matrix. In FIG. 1A to FIG. 1C, if there is a number in the grid representing the submatrix M2, it indicates that the submatrix M2 is an identity matrix, and the number in the grid represents the shift number of the identity matrix. If there is no number in the grid representing the submatrix M2, it indicates that the submatrix M2 is a zero matrix. For convenience of explanation, the following only takes a 7×7 identity matrix as an example to illustrate the shift number of the identity matrix. The 7×7 identity matrix is as shown in Table 1 below.

TABLE 1

| | | | | | | |
|---|---|---|---|---|---|---|
| 1 | 0 | 0 | 0 | 0 | 0 | 0 |
| 0 | 1 | 0 | 0 | 0 | 0 | 0 |
| 0 | 0 | 1 | 0 | 0 | 0 | 0 |
| 0 | 0 | 0 | 1 | 0 | 0 | 0 |
| 0 | 0 | 0 | 0 | 1 | 0 | 0 |
| 0 | 0 | 0 | 0 | 0 | 1 | 0 |
| 0 | 0 | 0 | 0 | 0 | 0 | 1 |

In some embodiments, the shift number of the identity matrix is a rightward shift number. When the shift number is 1 (that is, when the number in the grid representing the submatrix M2 is 1), the shifted identity matrix is as shown in Table 2 below.

TABLE 2

| | | | | | | |
|---|---|---|---|---|---|---|
| 0 | 1 | 0 | 0 | 0 | 0 | 0 |
| 0 | 0 | 1 | 0 | 0 | 0 | 0 |
| 0 | 0 | 0 | 1 | 0 | 0 | 0 |
| 0 | 0 | 0 | 0 | 1 | 0 | 0 |
| 0 | 0 | 0 | 0 | 0 | 1 | 0 |
| 0 | 0 | 0 | 0 | 0 | 0 | 1 |
| 1 | 0 | 0 | 0 | 0 | 0 | 0 |

When the shift number is 2 (that is, when the number in the grid representing the submatrix M2 is 2), the shifted identity matrix is as shown in Table 3 below.

TABLE 3

| | | | | | | |
|---|---|---|---|---|---|---|
| 0 | 0 | 1 | 0 | 0 | 0 | 0 |
| 0 | 0 | 0 | 1 | 0 | 0 | 0 |
| 0 | 0 | 0 | 0 | 1 | 0 | 0 |
| 0 | 0 | 0 | 0 | 0 | 1 | 0 |
| 0 | 0 | 0 | 0 | 0 | 0 | 1 |
| 1 | 0 | 0 | 0 | 0 | 0 | 0 |
| 0 | 1 | 0 | 0 | 0 | 0 | 0 |

As shown in Table 1 to Table 3, when the shift number is 1, all the 1 values in the identity matrix shift to the right by 1 column, and the 1 values in the rightmost column of the identity matrix shift to the leftmost column. When the shift number is 2, all the 1 values in the identity matrix shift to the right by 2 columns, and the 1 values in the two rightmost columns of the identity matrix shift to the two leftmost columns. The examples shown in Table 1 to Table 3 can be analogized to the case where the shift number is a number greater than 2 and the case of a 256×256 identity matrix. In some embodiments, the shift number of the identity matrix is a leftward shift number.

In FIG. 1A to FIG. 1C, for convenience of explanation, the sixty-nine columns C comprised in the parity check code matrix M1 are referred to as columns C0 to C68, and the submatrices M2 comprised in each of the columns C are the twelve submatrices M2 located directly below the column C. Taking the column C0 as an example, the submatrices M2 comprised in column C0 are twelve submatrices M2 located directly below the column C0, from the submatrix M2 with the shift number of 27 to the submatrix M2 with the shift number of 88.

In FIG. 1A to FIG. 1C, the parity check code matrix M1 is an LDPC check code adapted to the 25G PON, but the present disclosure is not limited thereto. In some embodiments, the parity check code matrix M1 may be an LDPC check code adapted to the PON of any rate (such as APON, BPON, EPON, and GPON), Ethernet, or other data communication protocols.

In FIG. 1A to FIG. 1C, the parity check code matrix M1 comprises sixty-nine columns C, and each of the columns C comprises twelve 256×256 submatrices M2, but the present disclosure is not limited thereto. In some embodiments, the parity check code matrix M1 may comprise any number of columns C, each of the columns C may comprise any number of submatrices M2, and the submatrices M2 may be of any size.

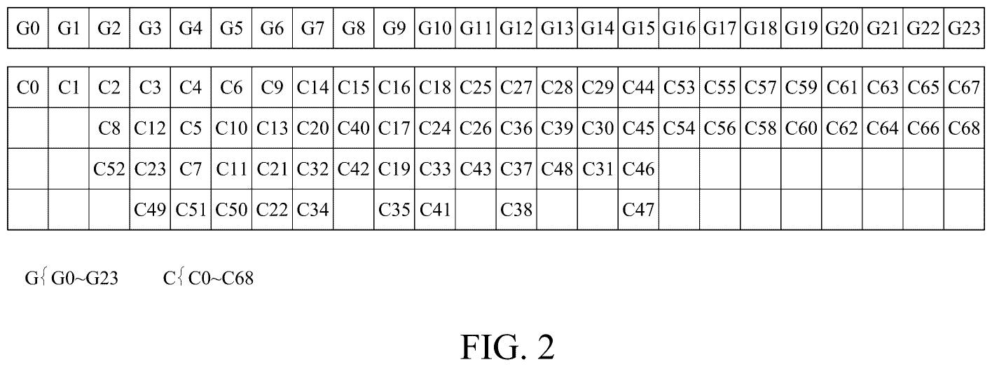

In some embodiments, the columns C comprised in the parity check code matrix M1 are grouped into a plurality of column groups G, and each of the column groups G comprises at least one column C. Please refer to FIG. 2. The columns C0 to C68 comprised in the parity check code matrix M1 shown in FIG. 1A to FIG. 1C are grouped into the column groups G shown in FIG. 2. For convenience of explanation, the column groups G are referred to as column groups G0 to G23, and the at least one column C comprised in each column group G is the at least one column C located directly below the column group G. Taking the column groups G0 to G3 as examples, the at least one column C comprised in the column group G0 is the column C0 located directly below the column group G0, the at least one column C comprised in the column group G1 is the column C1 located directly below the column group G1, the at least one column C comprised in the column group G2 are the column C2, the column C8, and the column C52 located directly below the column group G2, and the at least one column C comprised in the column group G3 are the column C3, the column C12, the column C23, and the column C49 located directly below column group G3. In some embodiments, the number of the columns C comprised in each of the column groups G ranges from 1 to 4, but the present disclosure is not limited thereto. The number of the columns C comprised in each of the column groups G may be any number.

In some embodiments, the grouping requirement for grouping the columns C comprised in the parity check code matrix M1 into the column groups G is that the number of the non-zero matrices in the same row of all columns C in each of the column groups G cannot exceed 1. Please refer to FIG. 1A to FIG. 1C and FIG. 2. Taking the column group G0 to G3 as examples, among the 1st to 12th rows of the column C0, only the 2nd row of the column C0 is a zero matrix, and the remaining rows of the column C0 are all non-zero matrices; however, among the columns C1 to C68, there is no column C with only the 2nd row of a non-zero matrix, so that the column C0 cannot be grouped with any other column C. Therefore, the column group G0 only comprises column C0. Similarly, all rows of the column C1 are all non-zero matrices, so that the column C1 cannot be grouped with any other column C. Therefore, the column group G1 only comprises column C1. The 1st, 5th, and 9th rows of the column C2 are non-zero matrices, and the remaining rows of the column C2 are all zero matrices. The 2nd, 7th, and 12th rows of the column C8 are non-zero matrices, and the remaining rows of the column C2 are all zero matrices. The 3rd, 4th, 6th, 8th, 10th, and 11th rows of the column C52 are non-zero matrices, and the remaining rows of the column C52 are all zero matrices. There is no more than one non-zero matrix in the same row of the column C2, the column C8, and the column C52, so that the column C2, the column C8, and the column C52 can be grouped into the same group. Therefore, the column group G2 comprises the column C2, the column C8, and the column C52. The 7th, 9th, and 10th rows of the column C3 are non-zero matrices, and the remaining rows of the column C3 are all zero matrices. The 2nd, 5th, and 11th rows of the column C12 are non-zero matrices, and the remaining rows of the column C12 are all zero matrices. The 1st, 8th, and 12th rows of the column C23 are non-zero matrices, and the remaining rows of the column C23 are all zero matrices. The 3rd, 4th, and 6th rows of the column C49 are non-zero matrices, and the remaining rows of the column C49 are all zero matrices. There is no more than one non-zero matrix in the same row of the column C3, the column C12, the column C23, and the column C49, so that the column C3, the column C12, the column C23, and the column C49 can be grouped into the same group. Therefore, the column group G3 comprises the column C3, the column C12, the column C23, and the column C49. From the above examples of the column groups G0 to G3, the grouping situation of the column groups G4 to G23 can be analogized.

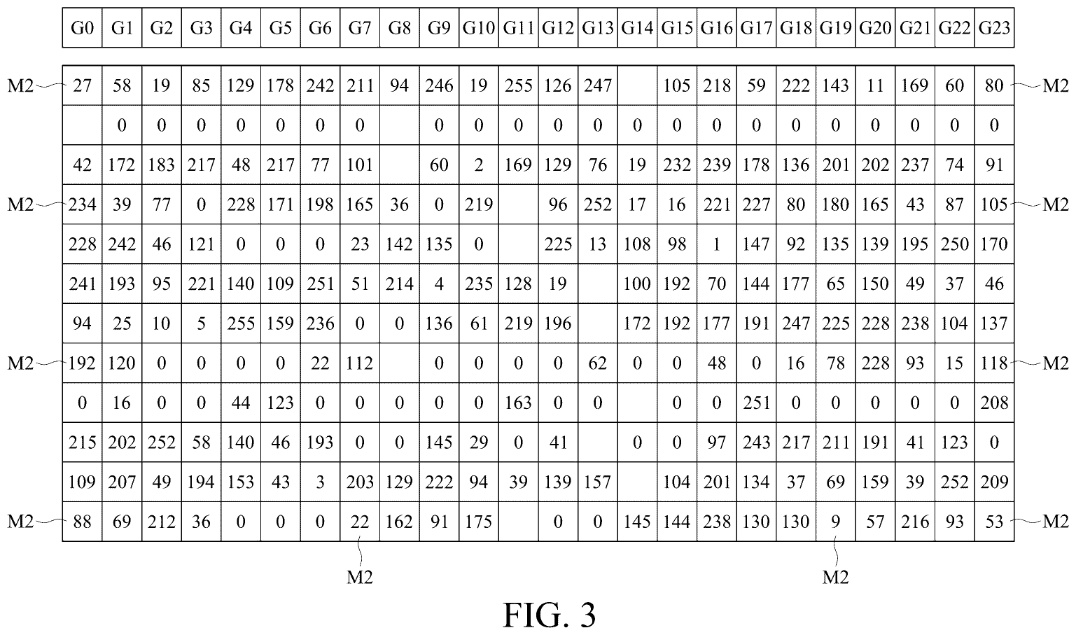

By grouping the columns C comprised in the parity check code matrix M1 into the column groups G, the zero matrices located in the same row of all columns C in each of the column groups G will be merged, and the number of the submatrices M2 comprised in each of the column groups G (i.e., the number of the rows of the submatrices M2 comprised in each of the column groups G) is the same as the number of the rows of the submatrices M2 comprised in the column C. For example, please refer to FIG. 3. Since both the column group G0 and the column group G1 only comprise one column C, the column group G0 and the column group G1 do not have zero matrices located in the same column will be merged. Since the column group G. comprises the column C2, the column C8 and the column C52, the zero matrices located in the same row of the column C2, the column C8 and the column C52 will be merged. Since the column group G3 comprises the column C3, the column C12, the column C23 and the column C49, the zero matrices located in the same row of the column C3, the column C12, the column C23 and the column C49 will be merged. The number of the submatrices M2 comprised in the column group G0, the column group G1, the column group G2 and the column group G3 is the number of the rows of the submatrices M2 comprised in the column C, which is 12. From the above examples of the column groups G0 to G3, the situation of the column groups G4 to G23 can be analogized.

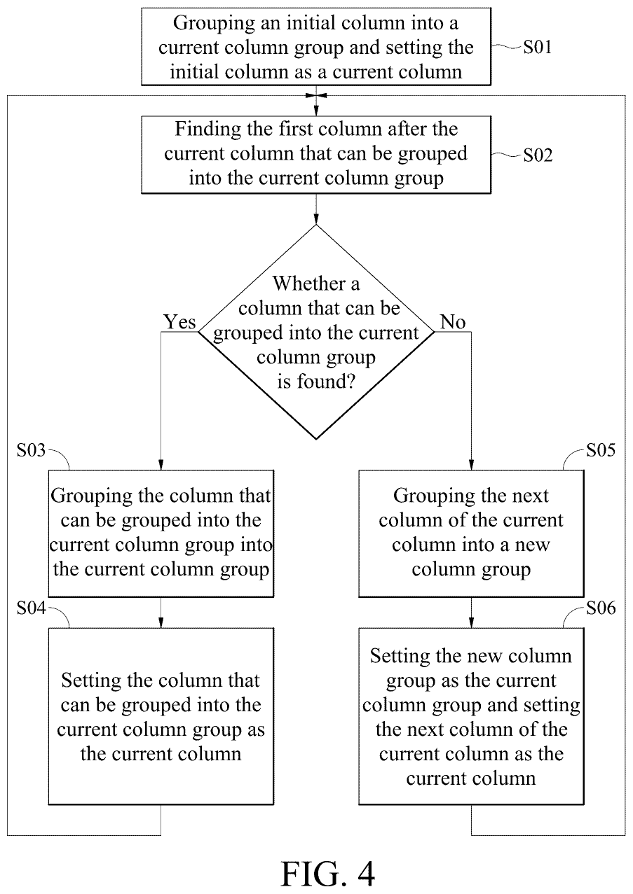

Please refer to FIG. 4. In some embodiments, a method for grouping the columns C comprised in the parity check code matrix M1 into the column groups G comprises the following steps in sequence: grouping an initial column C into a current column group G and setting the initial column C as a current column C (step S01); finding the first column C after the current column C that can be grouped into the current column group G (step S02); when a column C that can be grouped into the current column group G is found, grouping the column C that can be grouped into the current column group G into the current column group G (step S03); setting the column C that can be grouped into the current column group G as the current column C (step S04) and then executing the step S02 again; when no column C that can be grouped into the current column group G can be found, grouping the next column C of the current column C into a new column group G (step S05) and the current column group G is regarded as a full group; and setting the new column group G as the current column group G and setting the next column C of the current column C as the current column C (step S06) and then executing the step S02 again.

Please refer to FIG. 1A to FIG. 1C and FIG. 4. The method shown in FIG. 4 is exemplified by grouping the columns C comprised in the parity check code matrix M1 shown in FIG. 1A to FIG. 1C into the column groups G. First, the column C0 (i.e., the initial column C) is grouped into the column group G0 (i.e., the current column group G) and the column C0 is set as the current column C (step S01). Then, find the first column C after the column C0 that can be grouped into the column group G0 (step S02). When no column C that can be grouped into the column group G0 is found, the column group G0 is regarded as a full group, and the column C1 (i.e., the next column C of the column C0) is grouped into the column group G1 (i.e., the new column group G) (step S05) and the column group G1 is set as the current column group G and the column C1 is set as the current column C (step S06). Then, find the first column C after the column C1 that can be grouped into the column group G1 (step S02). When no column C that can be grouped into the column group G1 is found, the column group G1 is regarded as a full group, and the column C2 (i.e., the next column C of the column C1) is grouped into the column group G2 (i.e., the new column group G) (step S05) and the column group G2 is set as the current column group G and the column C2 is set as the current column C (step S06). Then, find the first column C after the column C2 that can be grouped into the column group G2 (step S02). When the column C6 that can be grouped into the column group G2 is found, the column C6 is grouped into the column group G2 (step S03) and the column C6 is set as the current column C (step S04). Then, find the first column C after the column C6 that can be grouped into the column group G2 (step S02). When the column C8 that can be grouped into the column group G2 is found, the column C8 is grouped into the column group G2 (step S03) and the column C8 is set as the current column C (step S04). Then, find the first column C after the column C8 that can be grouped into the column group G2 (step S02). When the column C49 that can be grouped into the column group G2 is found, the column C49 is grouped into the column group G2 (step S03) and the column C49 is set as the current column C (step S04). Then, find the first column C after the column C49 that can be grouped into the column group G2 (step S02).

When using the method illustrated in FIG. 4 to group the columns C comprised in the parity check code matrix M1 shown in FIG. 1A to FIG. 1C into the column groups G, the column C0 and the column C1 will be grouped independently, the column C2, the column C6, the column C8, and the column C49 will be grouped into the same column group G, the column C3, the column C4, and the column C5 will be grouped into the same column group G, and so on. The grouping results for the remaining columns C will not be described in detail here. In the above example, the column C0 is set as the initial column C, but the present disclosure is not limited thereto. In some embodiments, any column C comprised in the parity check code matrix M1 may be set as the initial column C.

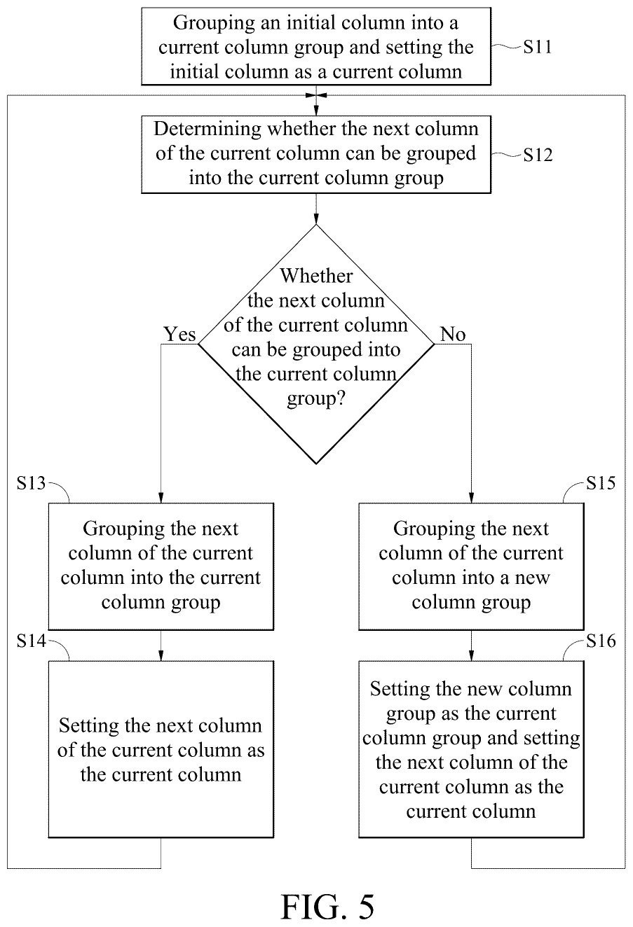

Please refer to FIG. 5. In some embodiments, the method for grouping the columns C comprised in the parity check code matrix M1 into the column groups G comprises the following steps in sequence: grouping an initial column C into a current column group G and setting the initial column C as a current column C (step S11); determining whether the next column C of the current column C can be grouped into the current column group G (step S12); when the next column C of the current column C can be grouped into the current column group G, grouping the next column C of the current column C into the current column group G (step S13); setting the next column C of the current column C as the current column C (step S14) and then executing the step S02 again; when the next column C of the current column C cannot be grouped into the current column group G, grouping the next column C of the current column C into a new column group G (step S15) and the current column group G is regarded as a full group; setting the new column group G as the current column group G and setting the next column C of the current column C as the current column C (step S16) and then executing the step S02 again.

Please refer to FIG. 1A to FIG. 1C and FIG. 5. The method shown in FIG. 5 is exemplified by grouping the columns C comprised in the parity check code matrix M1 shown in FIG. 1A to FIG. 1C into the column groups G. First, the column C0 (i.e., the initial column C) is grouped into the column group G0 (i.e., the current column group G) and the column C0 is set as the current column C (step S11). Then, determine whether the column C1 (i.e., the next column C of the column C0) can be grouped into the column group G0 (step S12). When the column C1 cannot be grouped into the column group G0, the column group G0 is regarded as a full group, and the column C1 (i.e., the next column C of the column C0) is grouped into the column group G1 (i.e., the new column group G) (step S15) and the column group G1 is set as the current column group G and the column C1 is set as the current column C (step S16). Then, determine whether the column C2 (i.e., the next column C of the column C1) can be grouped into the column group G1 (step S12). When the column C2 cannot be grouped into the column group G1, the column group G1 is regarded as a full group, and the column C2 (i.e., the next column C of the column C1) is grouped into the column group G2 (i.e., the new column group G) (step S15) and the column group G2 is set as the current column group G and the column C2 is set as the current column C (step S16). Then, determine whether the column C3 (i.e., the next column C of the column C2) can be grouped into the column group G2 (step S12). When the column C3 cannot be grouped into the column group G2, the column group G2 is regarded as a full group, and the column C3 (i.e., the next column C of the column C2) is grouped into the column group G3 (i.e., the new column group G) (step S15) and the column group G3 is set as the current column group G and the column C3 is set as the current column C (step S16). Then, determine whether the column C4 (i.e., the next column C of the column C3) can be grouped into the column group G3 (step S12). When the column C4 can be grouped into the column group G3, the column C4 is grouped into the column group G3 (step S13) and the column C4 is set as the current column C (step S14). Then, determine whether the column C5 (i.e., the next column C of the column C4) can be grouped into the column group G3 (step S12). When the column C5 can be grouped into the column group G3, the column C5 is grouped into the column group G3 (step S13) and the column C5 is set as the current column C (step S14). Then, determine whether the column C6 (i.e., the next column C of the column C5) can be grouped into the column group G3 (step S12).

When using the method illustrated in FIG. 5 to group the columns C comprised in the parity check code matrix M1 shown in FIG. 1A to FIG. 1C into the column groups G, the column C0, the column C1, and the column C2 will be grouped independently, the column C3, the column C4, and the column C5 will be grouped into the same column group G, the column C6 will be grouped independently, the column C7 and the column C8 will be grouped into the same column group G, the column C9 will be grouped independently, and so on. The grouping results for the remaining columns C will not be described in detail here. In the above example, the column C0 is set as the initial column C, but the present disclosure is not limited thereto. In some embodiments, any column C comprised in the parity check code matrix M1 may be set as the initial column C.

In some embodiments, the columns C comprised in the parity check code matrix M1 may be grouped into the column groups G through a trial and error method. In some embodiments, a computer program is configured to execute a trial and error method to group the columns C comprised in the parity check code matrix M1 into the column groups G, and the column groups G shown in FIG. 2 is the result of grouping through the trial and error method. In the embodiment of FIG. 2, the number of the column groups G is 24, but the present disclosure is not limited thereto. In some embodiments, the number of the column groups G may be any number. Since each of the columns C is assigned to only one column group G, the parity check code matrix M1 is able to be partitioned into tile layout groups without multiplexing between the partitions.

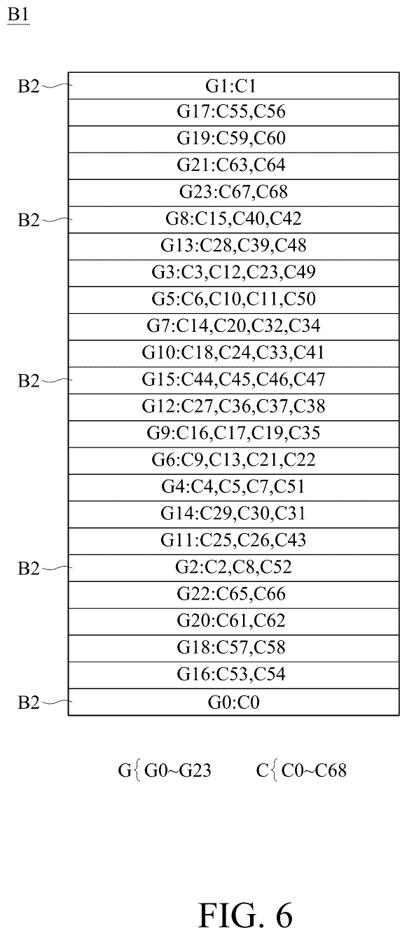

Please refer to FIG. 6. A parity check code storage block B1 comprises a plurality of column group storage blocks B2. The parity check code storage block B1 is configured to store the parity check code matrix M1. Each of the column group storage blocks B2 is configured to store one of the column groups G. The column groups G stored in the column group storage blocks B2 of FIG. 6 correspond to the column groups G of FIG. 2. The column group storage block B2 which stores the column group G comprising more of the columns Cis disposed closer to the center of the parity check code storage block B1. Taking the parity check code storage block B1 shown in FIG. 6 as an example, the number of the columns C comprised in each of the column groups G ranges from 1 to 4. The column group storage blocks B2 which store the column group G comprising 4 columns C (G15, G10, G12, G7, G9, G5, G6, G3, and G4) are disposed in the central region of the parity check code storage block B1. The column group storage blocks B2 which store the column group G comprising 3 columns C (G2, G8, G11, G13, and G14) are disposed relatively further from the center of the parity check code storage block B1 compared to the column group storage blocks B2 which store the column group G comprising 4 columns C. The column group storage blocks B2 which store the column group G comprising 2 columns C (G16, G17, G18, G19, G20, G21, G22, and G23) are disposed even further from the center of the parity check code storage block B1 compared to the column group storage blocks B2 which store the column group G comprising 3 columns C. The column group storage blocks B2 which store the column group G comprising only 1 column C (G0 and G1) are disposed at the edges of the parity check code storage block B1.

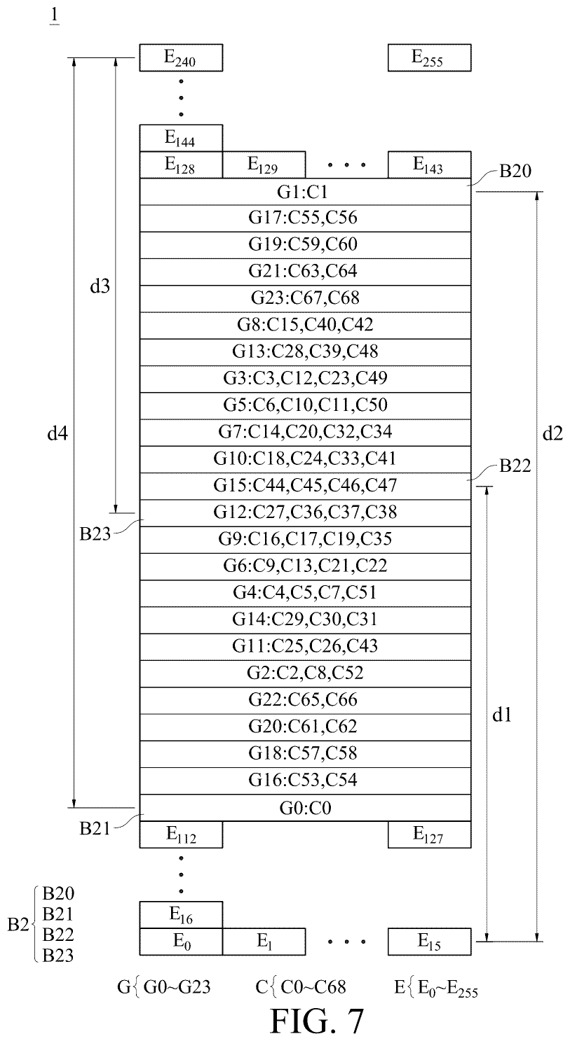

Please refer to FIG. 7. The low-density parity check (LDPC) decoder 1 comprises the parity check code storage block B1 and a plurality of computing engines E. In some embodiments, the computing engines E are disposed in a checkerboard arrangement on the two sides of the parity check code storage block B1. In the LDPC decoder 1 shown in FIG. 7, the number of the computing engines E is 256, but the present disclosure is not limited thereto. The number of the computing engines E may be any number. In some embodiments, the number of the computing engines E disposed on one of the two sides of the parity check code storage block B1 and the number of the computing engines E disposed on the other side of the parity check code storage block B1 are the same. Taking the LDPC decoder 1 in FIG. 7 as an example, when the number of the computing engines E is 256, the number of the computing engines E disposed on the one side of the parity check code storage block B1 and the number of the computing engines E disposed on the other side of the parity check code storage block B1 are both 128, but the present disclosure is not limited thereto. The number of the computing engines E disposed on the one side of the parity check code storage block B1 and the number of the computing engines E disposed on the other side of the parity check code storage block B1 may be different. In some embodiments, when the number of the computing engines E disposed on the one side of the parity check code storage block B1 and the number of the computing engines E disposed on the other side of the parity check code storage block B1 are both 128, the computing engines E are disposed in a 16×8 checkerboard arrangement on the two sides of the parity check code storage block B1, but the present disclosure is not limited thereto. The computing engines E may be disposed in a checkerboard arrangement of any size on the two sides of the parity check code storage block B1. In some embodiments, the LDPC decoder 1 is a 25G PON decoder, but the present disclosure is not limited thereto. In some embodiments, the LDPC decoder 1 may be a decoder adapted to the PON of any rate (such as APON, BPON, EPON, and GPON), Ethernet, or other data communication protocols. In some embodiments, the computing engines E are symmetrically disposed on the two sides of the parity check code storage block B1.

By grouping the columns C comprised in the parity check code matrix M1 into the column groups G, the zero matrices located in the same row of all columns C in each of the column groups G will be merged. Therefore, the computing engines E do not need to perform computations on the merged zero matrices, thereby enhancing the computing speed of the computing engines E and reducing the number of required signals of the computing engines E. The computer-aided design (CAD) tools for placement and routing can successfully place and route the LDPC decoder 1 in FIG. 7. The CAD tool will not encounter the problem of being unable to place and route the LDPC decoder 1 due to the use of too many computing engines E. Because the LDPC decoder 1 can use 256 computing engines E to perform computations on the parity check code matrix M1 stored in the parity check code storage block B1 for decoding and error correction, the required clock speed of the LDPC decoder 1 can be greatly reduced, leading to a substantial decrease in power consumption.

In the LDPC decoder 1 of FIG. 7, for convenience of explanation, the computing engines E are referred to as computing engines E0 to E255. A distance d2 between the column group storage block B2 which stores the column group G1 (hereinafter referred to as the column group storage block B20) and the computing engine E15 is the farthest vertical distance from the column group storage block B20 to the computing engines E. A distance d1 between the column group storage block B2 which stores the column group G15 (hereinafter referred to as the column group storage block B22) and the computing engine E15 is the farthest vertical distance from the column group storage block B22 to the computing engines E. A distance d4 between the column group storage block B2 which stores the column group G0 (hereinafter referred to as the column group storage block B21) and the computing engine E240 is the farthest vertical distance from the column group storage block B21 to the computing engines E. A distance d3 between the column group storage block B2 which stores the column group G12 (hereinafter referred to as the column group storage block B23) and the computing engine E240 is the farthest vertical distance from the column group storage block B23 to the computing engines E. In some embodiments, the distance d2 and the distance d4 are equal in length, and the distance d1 and the distance d3 are equal in length, but the present disclosure is not limited thereto.

In some embodiments, the computing engines E perform computations on the parity check code matrix M1 stored in the parity check code storage block B1 by using the log-likelihood ratio (LLR) minimum-sum algorithm to decode and correct the parity check code matrix M1. In some embodiments, the log-likelihood ratio represents accuracy through precision bits. In some embodiments, each of the column group storage block B2 comprises 6 precision bits, but the present disclosure is not limited thereto. Each of the column group storage block B2 may comprise any number of the precision bits. In some embodiments, the 6 precision bits comprise 1 sign bit and 5 value bits. In some embodiments, the number of the precision bits is determined through extensive experiments on a large field programmable gate array (FPGA) test platform. In some embodiments, each of the computing engines E comprises 288 signals (24 (the number of the column group storage blocks B2)*6 (the number of the precision bits)*2 (input and output)=288).

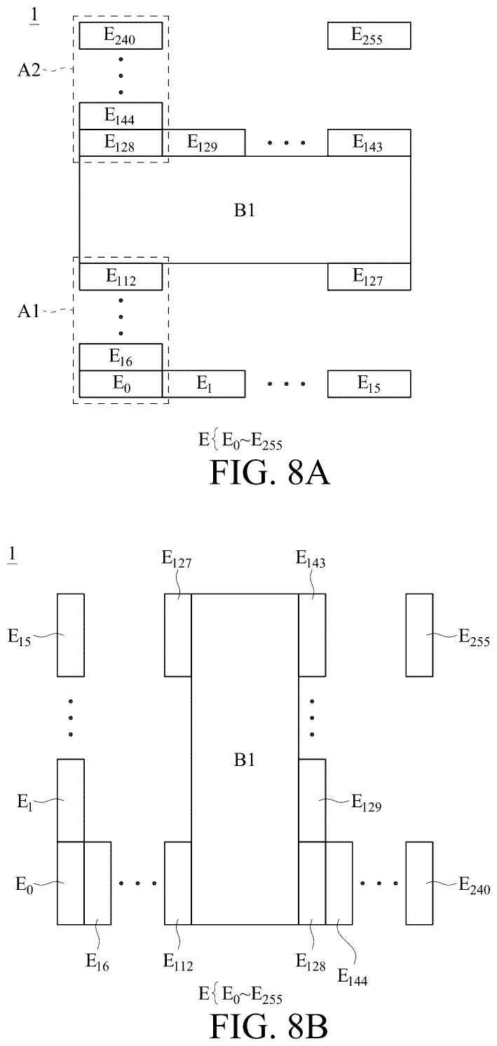

Please refer to FIG. 8A and FIG. 8B. In some embodiments, the computing engines E are disposed in a checkerboard arrangement on the upper side and the lower side of the parity check code storage block B1 (as shown in FIG. 8A). In some embodiments, the computing engines E are disposed in a checkerboard arrangement on the left side and the right side of the parity check code storage block B1 (as shown in FIG. 8B). In some embodiments, the layout of the LDPC decoder 1 shown in FIG. 8B is the layout rotated 90 degrees from the layout of the LDPC decoder 1 shown in FIG. 8A. In some embodiments, if the number of available horizontal routing wires is greater than the number of available vertical routing wires in the IC fabrication process, the layout of the LDPC decoder 1 shown in FIG. 8B may be more suitable than the layout of the LDPC decoder 1 shown in FIG. 8A.

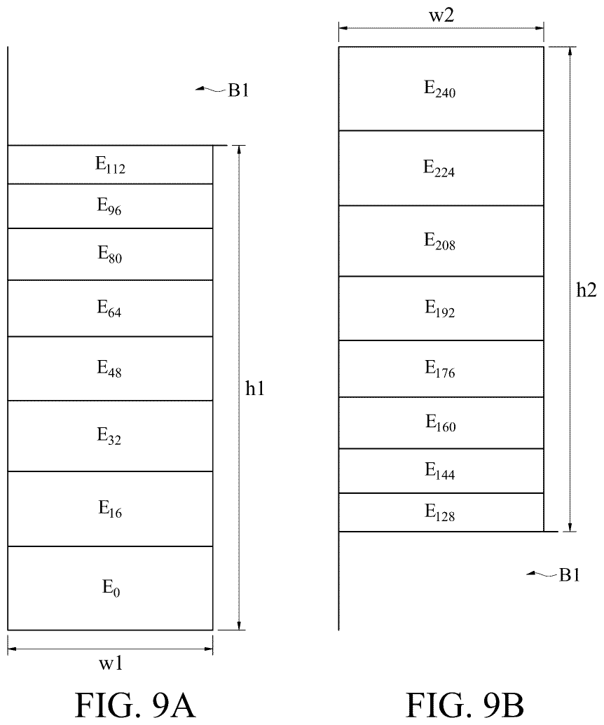

Please refer to FIG. 9A and FIG. 9B. In some embodiments, the computing engines E in the same column among the computing engines E arranged in a checkerboard arrangement on of the two sides of the parity check code storage block B1 comprise a plurality of wires. Taking the 8 computing engines E in the same column at the lower side of the parity check code storage block B1 as shown in FIG. 9A and the 8 computing engines E in the same column at the upper side of the parity check code storage block B1 as shown in FIG. 9B as examples, when the number of the column group storage blocks B2 is 24 and each of the column group storage block B2 comprises 6 precision bits, the number of wires comprised in the 8 computing engines E shown in FIG. 9A and the 8 computing engines E shown in FIG. 9B are both 2304 (8 (the number of the computing engines E)*24 (the number of the column group storage blocks B2)*6 (the number of the precision bits)*2 (input and output)=2304). When the LDPC decoder 1 is manufactured by using the 12-nanometer (nm) process of Taiwan Semiconductor Manufacturing Company (TSMC), the width w1 of the 8 computing engines E shown in FIG. 9A and the width w2 of the 8 computing engines E shown in FIG. 9B are both 92.16 (um) (2304 (the number of wires)*0.08 micrometers (um) (the width of the wire)/2 (the number of wire layers)=92.16 (um)). The width of the wire and the number of wire layers are determined by TSMC's 12 nm process. In some embodiments, the width of the wire and the number of wire layers are determined by the process used by the LDPC decoder 1.

In some embodiments, the computing engine E which is further away from the parity check code storage block B1 has a larger circuit area and a faster computing speed. Taking FIG. 9A as an example, the computing engine E96 has a larger circuit area and a faster computing speed as compared with the computing engine E112. The computing engine E80 has a larger circuit area and a faster computing speed as compared with the computing engine E96, and so on. The computing engine E0 has the largest circuit area and the fastest computing speed among the computing engines E shown in FIG. 9A. Similarly, the computing engine E240 has the largest circuit area and the fastest computing speed among the computing engines E shown in FIG. 9B. In some embodiments, the circuit area of the computing engine E with the largest circuit area among the computing engines E disposed in the same column (i.e., the computing engine E0 in FIG. 9A or the computing engine E240 in FIG. 9B) may be, but is not limited to 3000 square micrometers (squm). Taking FIG. 9A as an example, assuming that the width w1 of the 8 computing engines E is 92.16 um and the circuit area of the computing engine E0 is 3000 squm, the height of the computing engine E0 is 32.55 (um) (3000 (squm)/91.6 (um)=32.55 (um)). In some embodiments, the circuit area of the computing engine E with the smallest circuit area among the computing engines E disposed in the same column (i.e., the computing engine E112 in FIG. 9A or the computing engine E128 in FIG. 9B) may be, but is not limited to 2000 square nanometers (squm). Taking FIG. 9A as an example, assuming that the width w1 of the 8 computing engines E is 92.16 um and the circuit area of the computing engine E112 is 3000 squm, the height of the computing engine E112 is 21.7 (um) (2000 (squm)/91.6 (um)=21.7 (um)).

Due to the considerable distance from the parity check code storage block B1 to the farthest computing engine E (i.e., the total height h1 of the 8 computing engines E in FIG. 9A and the total height h2 of the 8 computing engines E in FIG. 9B) (Taking the total height h1 and the total height h2 as examples, the distance from the parity check code storage block B1 to the farthest computing engine E is approximately 217 (um) (21.7 (um)+32.55 (um)/2*8=217 (um))). Therefore, in some embodiments, it may be necessary to dispose buffer zones between some of two adjacent computing engines E of the computing engines E to segment the computing engines E in the same column so as to enhance the strength of signals from the parity check code storage block B1, thereby preventing the signals from the parity check code storage block B1 from taking too long to propagate to some of the computing engines E.

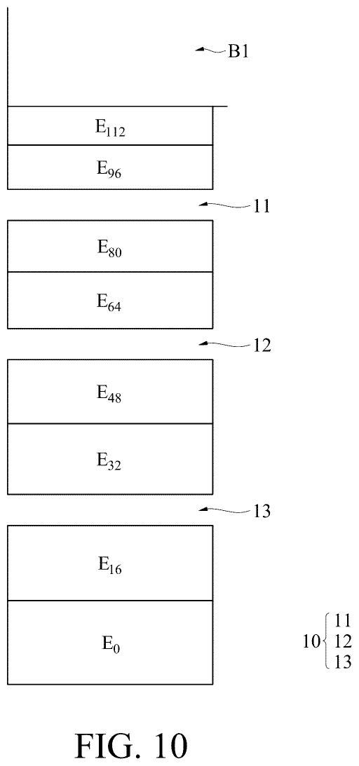

Please refer to FIG. 10. In some embodiments, a buffer zone 10 is disposed between some of two adjacent computing engines E in the same column, and a plurality of buffer zones 10 are disposed among the computing engines E in the same column. For convenience of explanation, the buffer zones 10 shown in FIG. 10 are respectively referred to as buffer zone 11, buffer zone 12, and buffer zone 13. The signal from the parity check code storage block B1 have to be propagated to the computing engine E112, the computing engines E96, the computing engines E80, the computing engines E64, the computing engines E48, the computing engines E32, the computing engines E16, and the computing engines E0. The signal passing through the buffer zone 11 has to be propagated to the computing engine E80, the computing engine E64, the computing engine E48, the computing engine E32, the computing engine E16, and the computing engine E0. The signal passing through the buffer zone 12 has to be propagated to the computing engine E48, the computing engine E32, the computing engine E16, and the computing engine E0. The signal passing through the buffer zone 13 just has to be propagated to the computing engine E16 and the computing engine E0. Therefore, the buffering capacity of the buffer zone 11 (i.e., the signal strength enhancement capability) has to be greater than the buffering capacity of the buffer zone 12 and the buffer zone 13, and the buffering capacity of the buffer zone 12 also has to be greater than the buffering capacity of the buffer zone 13. In some embodiments, the buffer zone 10 comprises one or more buffer units. The greater the number of the buffer units comprised in the buffer zone 10, the stronger the buffering capacity. Therefore, the number of the buffer units comprised in the buffer zone 11 is greater than the number of the buffer units comprised in the buffer zone 12 and the buffer zone 13, and the number of the buffer units comprised in the buffer zone 12 is also greater than the number of the buffer units comprised in the buffer zone 13. The greater the number of the buffer units comprised in the buffer zone 10, the larger its circuit area. Therefore, the circuit area of the buffer zone 11 is larger than the circuit area of the buffer zone 12 and the buffer zone 13, and the circuit area of the buffer zone 12 is also larger than the circuit area of the buffer zone 13. In some embodiments, the placement locations of the buffer zones 10 and the number of the buffer units comprised in each of the buffer zones 10 are determined based on the resistance (R) value, inductance (L) value, and capacitance (C) value of the wire. In some embodiments, the buffer unit may be, but is not limited to, a buffer gate. In some embodiments, the computing engines E and the buffer units are symmetrically disposed on the two sides of the parity check code storage block B1.

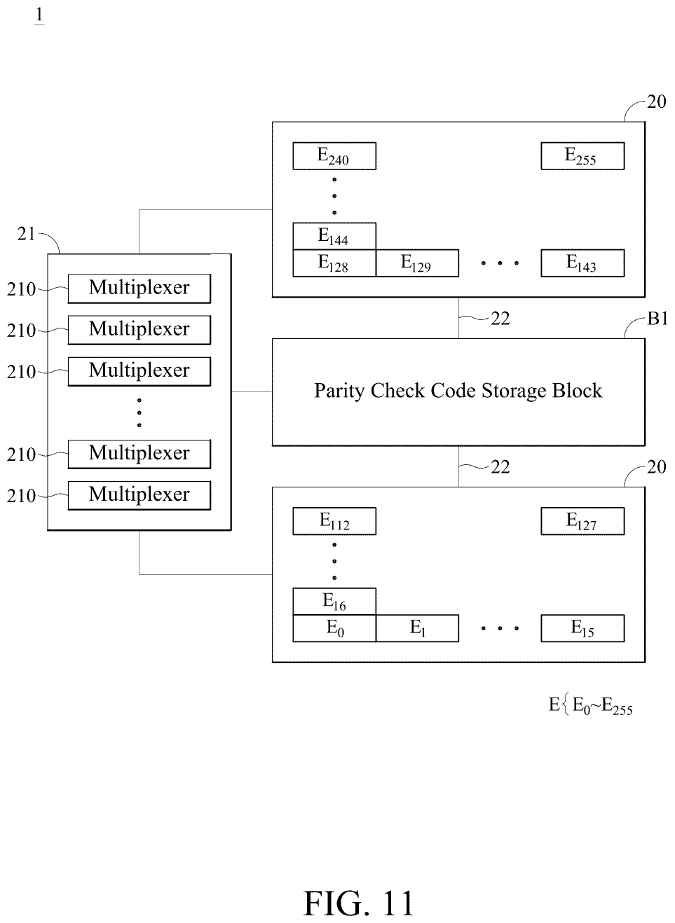

Please refer to FIG. 11. The low-density parity check (LDPC) decoder 1 comprises the parity check code storage block B1, a computing circuit 20, and a multiplexing circuit 21. The computing circuit 20 is directly connected to the parity check code storage block B1 through a wire 22. The multiplexing circuit 21 is coupled between the parity check code storage block B1 and the computing circuit 20. The parity check code storage block B1 shown in FIG. 11 is the parity check code storage block B1 shown in FIG. 6. In some embodiments, the computing circuit 20 comprises a plurality of computing engines E, and the computing engines E are disposed in the checkerboard arrangement on the two sides of the parity check code storage block B1. The multiplexing circuit 21 comprises a plurality of multiplexers 210. The location of the multiplexing circuit 21 is not limited here.

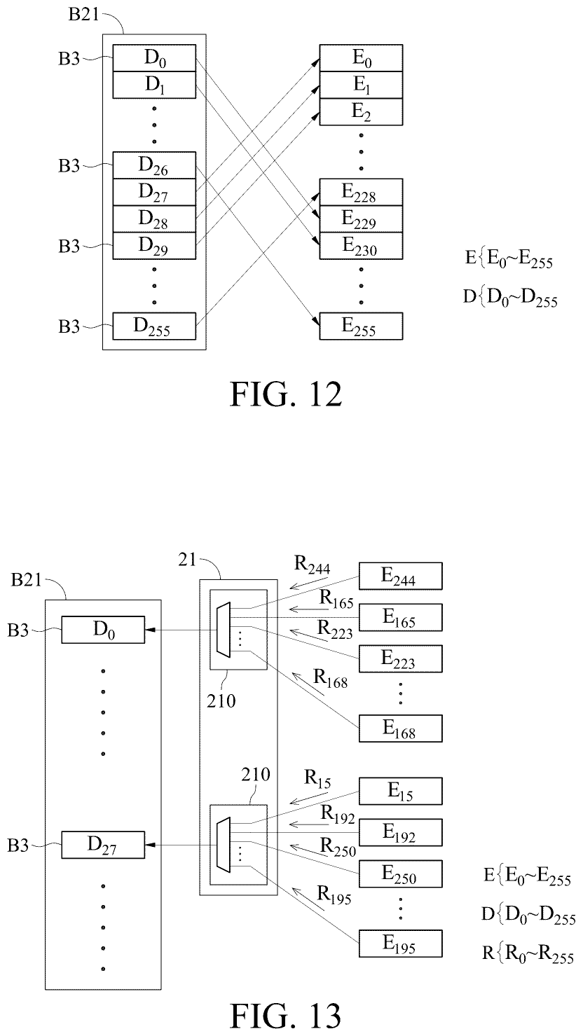

Please refer to FIG. 1A, FIG. 3, FIG. 6 and FIG. 12. In some embodiments, if the submatrix M2 is a non-zero matrix (i.e., the shifted identity matrix), the submatrix M2 comprises a plurality of bits D. The bits D are elements with a value of 1 comprised in the submatrix M2, that is, in this embodiment, the value of each of the bits D is 1 and the number of the bits D is the number of the columns of the submatrix M2. In some embodiments, each of the column group storage blocks B2 comprises a plurality of bit storage blocks B3, and each of the bit storage blocks B3 is configured to store one of the bits D of each of the submatrices M2. The bit storage blocks B3 shown in FIG. 12 are the bit storage blocks B3 comprised in the column group storage block B21, and the bit storage blocks B3 shown in FIG. 12 are configured to store the bits D comprised in the submatrix M2 of the first row of the column group G0. Since each of the submatrices M2 comprised in the column group G0 is a 256×256 matrix, the number of bits D shown in FIG. 12 is 256. The bits D shown in FIG. 12 are referred to as bits D0 to D255 according to the columns in which each of the bits D is located (that is, the element with a value of 1 comprised in the first column of the submatrix M2 is bit D0, the element with a value of 1 comprised in the second column of the submatrix M2 is bit DI, and so on). In some embodiments, the number of the bits D is the same as the number of the computing engines E, but the present disclosure is not limited thereto.

In some embodiments, each of the bits D is computed by a corresponding one of the computing engines E, and the computing engines E corresponding to the bits D are different computing engines E. In some embodiments, each of the bit storage blocks B3 is directly connected to the corresponding one of the computing engines E through the wire 22, and each of the bits D is transmitted to the corresponding one of the computing engines E through the wire 22. In some embodiments, each of the bits D determines the corresponding one of the computing engines E according to the shift number of the submatrix M2 of which each of the bits D is located. When the shift number of the submatrix M2 is n, the bit Dn of the submatrix M2 corresponds to the computing engine E0, the bit Dn+1 of the submatrix M2 corresponds to the computing engine E1, the bit Dn+2 of the submatrix M2 corresponds to the computing engine E2, and by analogy, the bit Dn+m of the submatrix M2 corresponds to the computing engine Em. Likewise, the bit D0 to the bit Dn−1 of the submatrix M2 correspond to the computing engine Em+1 to the computing engine Em+n. Taking FIG. 12 as an example, since the shift number of the submatrix M2 of the first row of the column group G0 is 27, the bit D27 of the submatrix M2 of the first row of the column group G0 corresponds to the computing engine E0, the bit D28 of the submatrix M2 of the first row of the column group G0 corresponds to the computing engine E1, the bit D29 of the submatrix M2 of the first row of the column group G0 corresponds to the computing engine E2, and by analogy, the bit D255 of the submatrix M2 of the first row of the column group G0 corresponds to the computing engine E228. Likewise, the bit D0 to the bit D26 of the submatrix M2 of the first row of the column group G0 correspond to the computing engine E229 to the computing engine E255. Taking the submatrix M2 of the first row of the column group G1 in FIG. 1A as an example (not shown in FIG. 12), since the shift number of the submatrix M2 of the first row of the column group G1 is 58, the bit D58 of the submatrix M2 of the first row of the column group G1 corresponds to the computing engine E0, the bit D59 of the submatrix M2 of the first row of the column group G1 corresponds to the computing engine E1, the bit D60 of the submatrix M2 of the first row of the column group G1 corresponds to the computing engine E2, and by analogy, the bit D255 of the submatrix M2 of the first row of the column group G01 corresponds to the computing engine E197. Likewise, the bit D0 to the bit D57 of the submatrix M2 of the first row of the column group G1 correspond to the computing engine E198 to the computing engine E255.

In some embodiments, the computing engines E are configured to perform computations on the bits D to obtain a plurality of computing results. In some embodiments, if the submatrix M2 is a zero matrix, the computing engines E do not perform computations on the submatrix M2. In some embodiments, the multiplexers 210 are configured to multiplex the computing results R and transmit the computing results R to the parity check code storage block B1. In some embodiments, the computing results R are transmitted to the bit storage blocks B3. In some embodiments, each of the computing results R corresponds to one of the computing engines E. The computing results R corresponding to the computing engines E0 to E255 are referred to as computing results R0 to R255. In some embodiments, each of the multiplexers 210 determines the computing results R to be multiplexed and the bit storage blocks B3 to which the computing results R to be multiplexed are transmitted corresponding to the computing results R to be multiplexed according to the shift number of the submatrices M2 comprised in each of the column groups G.

When the shift number of the submatrix M2 of the a-th row of the column group G is n, the multiplexer 210 coupled to the bit storage block B3 storing the bit Dn of the submatrix M2 configured to store the a-th row of the column group G is configured to multiplex computing results Rthe shift number of the submatrix M2 one row below the a-th row-n, Rthe shift number of the submatrix M2 two rows below the a-th row—the shift number of the submatrix M2 one row below the a-th row, Rthe shift number of the submatrix M2 three rows below the a-th row—the shift number of the submatrix M2 two rows below the a-th row, and so on, up to c computing results, and transmit these c computing results R to the bit storage block B3 storing the bit Dn of the submatrix M2 configured to store the a-th row of the column group G. The last computing result R multiplexed by the multiplexer 210 coupled to the bit storage block B3 storing the bit Dn of the submatrix M2 configured to store the a-th row of the column group G is computing result Rn—the shift number of the submatrix M2 one row above the a-th row. That is, computing engines Ethe shift number of the submatrix M2 one row below the a-th row-n, Ethe shift number of the submatrix M2 two rows below the a-th row—the shift number of the submatrix M2 one row below the a-th row, Ethe shift number of the submatrix M2 three rows below the a-th row—the shift number of the submatrix M2 two rows below the a-th row, En—the shift number of the submatrix M2 one row above the a-th row, and so on, up to c computing engines E are coupled to the input of the multiplexer 210. For the convenience of explanation, the shift number of the submatrix M2 one row below the a-th row minus n, the shift number of the submatrix M2 two rows below the a-th row minus the shift number of the submatrix M2 one row below the a-th row, the shift number of the submatrix M2 three rows below the a-th row minus the shift number of the submatrix M2 two rows below the a-th row, and so on, are referred to as shift number differences. If all of the submatrices M2 of the column group G are non-zero matrices, c is the number of rows in the column group G (i.e., the number of rows in column C). If the column group G comprises the submatrix M2 which is a zero matrix, c is the number of rows in the column group G minus the number of the submatrices M2 which are zero matrices in the column group G. It should be noted that when computing the shift number differences, if the submatrix M2 of a row is a zero matrix, since the zero matrix has no shift number, the shift number of the submatrix M2 of this row will be skipped and not computed (see the example below). Also, if the shift number difference is negative, the computing result R multiplexed by the multiplexer 210 is computing result Rthe number of the computing results R+ (the shift number difference) (see the example below).

Please refer to FIG. 1A, FIG. 3, FIG. 6 and FIG. 13. The bit storage blocks B3 shown in FIG. 13 are the bit storage blocks B3 comprised in the column group storage block B21, and the bit storage blocks B3 shown in FIG. 13 are configured to store the bits D comprised in the submatrix M2 of the first row of the column group G0. Since the shift number of the submatrix M2 of the first row of the column group G0 is 27, the multiplexer 210 coupled to the bit storage block B3 storing the bit D27 of the submatrix M2 configured to store the first row of the column group G0 is configured to multiplex computing result R42-27 (i.e., computing result R15), R234-42 (i.e., computing result R192), R228-234 (i.e., computing result R250), and so on, and transmit these computing results R to the bit storage block B3 storing the bit D27 of the submatrix M2 configured to store the first row of the column group G0. The last computing result R multiplexed by the multiplexer 210 coupled to the bit storage block B3 storing the bit D27 of the submatrix M2 configured to store the first row of the column group G0 is computing result R27-88 (i.e., computing result R195). That is, computing engines E15, E192, E250, E195, and so on, are coupled to the input of the multiplexer 210. Since the column group G0 comprises one submatrix M2 which is a zero matrix, the number of the computing results R multiplexed by the multiplexer 210 coupled to the bit storage block B3 of the bit D27 (i.e., c) is 11, which is the number of rows in the column group G0 (i.e., 12) minus the number of the submatrices M2 which are zero matrices in the column group G0 (i.e., 1). It should be noted that since the submatrix M2 of the second row of the column group G0 is a zero matrix, the shift number of the submatrix M2 of the second column of the column group G0 will be skipped and not computed. The computing result R15 is obtained by directly using the shift number of the submatrix M2 of the third row of the column group G0 (i.e., 42) to subtract the shift number of the submatrix M2 of the first row of the column group G0 (i.e., 27). When the shift number are negative numbers (that is, the shift number are the aforementioned −6 (228−234) and −61 (27−88)), the computing results R multiplexed by the multiplexer 210 coupled to the bit storage block B3 storing the bit D27 of the submatrix M2 configured to store the first row of the column group G0 are computing result R256+−6) (i.e., R250) and R256+(−61) (i.e., R195), respectively.

Another example is illustrated (not shown in FIG. 13), since the shift number of the submatrix M2 of the first row of the column group G1 is 58, the multiplexer 210 coupled to the bit storage block B3 storing the bit D58 of the submatrix M2 configured to store the first row of the column group G1 is configured to multiplex computing result R0-58 (i.e., computing result R198), R172-0 (i.e., computing result R172), R39-172 (i.e., computing result R123), and so on, and transmit these computing results R to the bit storage block B3 storing the bit D58 of the submatrix M2 configured to store the first row of the column group G1. The last computing result R multiplexed by the multiplexer 210 coupled to the bit storage block B3 storing the bit D58 of the submatrix M2 configured to store the first row of the column group G1 is computing result R58-69 (i.e., computing result R245). That is, computing engines E198, E172, E123, E245, and so on, are coupled to the input of the multiplexer 210. Since all of the submatrices M2 of the column group G1 are non-zero matrices, the number of the computing results R multiplexed by the multiplexer 210 coupled to the bit storage block B3 storing the bit D58 is the number of rows of the column group G1, which is 12. When the shift number are negative numbers (that is, the shift number are the aforementioned −58 (0−58), −133 (39−172), and −11 (58−69)), the computing results R multiplexed by the multiplexer 210 coupled to the bit storage block B3 storing the bit D58 of the submatrix M2 configured to store the first row of the column group G1 are computing result R256+(−58) (i.e., R198), R256+(−133) (i.e., R112), and R256+(−11) (i.e., R245), respectively.

In some embodiments, the computing results R multiplexed by the multiplexer 210 coupled to the bit storage block B3 storing the bit Db (b≠n) of the submatrix M2 of the a-th row of the column group G are determined based on the computing results R multiplexed by the multiplexer 210 coupled to the bit storage block B3 storing the bit Dn of the submatrix M2 of the a-th row of the column group G and the difference between n and b. When the computing result R multiplexed by the multiplexer 210 coupled to the bit storage block B3 storing the bit Dn of the submatrix M2 of the a-th row of the column group G is Rx (X is any positive integer), the computing result R multiplexed by the multiplexer 210 coupled to the bit storage block B3 storing the bit Db of the submatrix M2 of the a-th row of the column group G is Rx−(n−b).

Please refer to FIG. 1A, FIG. 3, FIG. 6 and FIG. 13. The multiplexer 210 coupled to the bit storage block B3 storing the bit D27 of the submatrix M2 of the first row of the column group G0 is configured to multiplex computing result R15, R192, R250, R195, and so on. Because the difference between n and b is 27 (i.e., 27−0=27), the multiplexer 210 coupled to the bit storage block B3 storing the bit D0 of the submatrix M2 of the first row of the column group G0 is configured to multiplex computing result R15-27 (i.e., computing result R244), R192-27 (i.e., computing result R165), R250-227 (i.e., computing result R223), and so on, and transmit these computing results R to the bit storage block B3 storing the bit D0 of the submatrix M2 configured to store the first row of the column group G0. The last computing result R multiplexed by the multiplexer 210 coupled to the bit storage block B3 storing the bit D0 of the submatrix M2 configured to store the first row of the column group G0 is computing result R195-27 (i.e., computing result R168). That is, computing engines E244, E165, E223, E168, and so on, are coupled to the input of the multiplexer 210.

It is hereby specifically explained that, although the number of the computing results R multiplexed by the multiplexer 210 coupled to the bit storage block B3 storing the bit D27 of the submatrix M2 configured to store the first row of the column group G0 and the number of the computing results R multiplexed by the multiplexer 210 coupled to the bit storage block B3 storing the bit D0 of the submatrix M2 configured to store the first row of the column group G0 are both 11, for convenience of explanation, only four of them are shown in FIG. 13.

In some embodiments, the multiplexers 210 are configured to multiplex the bits D and transmit the bits D to the computing engines E. In some embodiments, each of the computing engines E is directly connected to a corresponding one of the bit storage blocks B3 through the wire 22, and each of the computing results R is transmitted to the corresponding one of the bit storage blocks B3 through the wire 22.

Because when the LDPC decoder 1 multiplexes the computing results R, the bits D are directly transmitted to the computing engines E through the wire 22, and when the LDPC decoder 1 multiplexes the bits D, the computing results R are directly transmitted to the parity check code storage block B1 through the wire 22. In other words, according to some embodiments, the LDPC decoder 1 only multiplexes data in one direction. That is, only one set of multiplexing circuits 21 comprising the multiplexers 210 is disposed between the parity check code storage block B1 of the LDPC decoder 1 and the computing engines E. Since the LDPC decoder 1 reduces one set of multiplexing circuits comprising multiple 12-to-1 multiplexers compared to the relevant art known to the inventor, the clock speed of the LDPC decoder 1 can be enhanced, and the power consumption and circuit area of the LDPC decoder 1 can also be reduced as a result.

In some embodiments, the number of inputs of the multiplexers 210 is determined according to the number of rows of the array of the submatrices M2. In the LDPC decoder 1 shown in FIG. 11, since the parity check code matrix M1 is composed of a 69×12 array of 256×256 submatrices M2, the multiplexers 210 are all 12-to-1 multiplexers, but the present disclosure is not limited thereto.

To sum up, in some embodiments, the LDPC decoder 1 only multiplexes data in one direction. That is, only one set of multiplexing circuits 21 comprising the multiplexers 210 is disposed between the parity check code storage block B1 of the LDPC decoder 1 and the computing engines E. Since the LDPC decoder 1 reduces one set of multiplexing circuits comprising multiple 12-to-1 multiplexers compared to the relevant art known to the inventor, the clock speed of the LDPC decoder 1 can be enhanced, and the power consumption and circuit area of the LDPC decoder 1 can also be reduced as a result.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A low-density parity check (LDPC) decoder, comprising:
a parity check code storage block configured to store a parity check code matrix, wherein the parity check code matrix comprises a plurality of columns, each of the columns comprises a plurality of submatrices, each of the submatrices comprises a plurality of bits, the parity check code storage block comprises a plurality of column group storage blocks, and each of the column group storage blocks is configured to store a column group comprising at least one of the columns;
a computing circuit directly connected to the parity check code storage block; and
a multiplexing circuit coupled between the parity check code storage block and the computing circuit.

2. The LDPC decoder according to claim 1, wherein the computing circuit comprises a plurality of computing engines, the multiplexing circuit comprises a plurality of multiplexers, the bits comprised in the submatrices are transmitted to the computing engines, the computing engines are configured to perform computations on the bits to obtain a plurality of computing results, and the multiplexers are configured to multiplex the computing results and transmit the computing results to the parity check code storage block.

3. The LDPC decoder according to claim 1, wherein the computing circuit comprises a plurality of computing engines, the multiplexing circuit comprises a plurality of multiplexers, the multiplexers are configured to multiplex the bits comprised in the submatrices and transmit the bits to the computing engines, the computing engines are configured to perform computations on the bits to obtain a plurality of computing results, and the computing results are transmitted to the parity check code storage block.

4. The LDPC decoder according to claim 2, wherein the LDPC decoder is a 25G passive optical network (PON) decoder.

5. The LDPC decoder according to claim 3, wherein the LDPC decoder is a 25G optical network (PON) decoder.

6. The LDPC decoder according to claim 4, wherein the number of the computing engines is 256.

7. The LDPC decoder according to claim 5, wherein the number of the computing engines is 256.

8. The LDPC decoder according to claim 6, wherein the multiplexers are all 12-to-1 multiplexers.

9. The LDPC decoder according to claim 7, wherein the multiplexers are all 12-to-1 multiplexers.

10. The LDPC decoder according to claim 1, wherein each of the column group storage blocks comprises 6 precision bits.

11. The LDPC decoder according to claim 10, wherein the 6 precision bits comprise 1 sign bit and 5 value bits.

12. The LDPC decoder according to claim 1, wherein the number of the column group storage blocks is 24.

13. The LDPC decoder according to claim 1, wherein the number of the columns comprised in each of the column groups ranges from 1 to 4.

14. The LDPC decoder according to claim 1, wherein each of the columns is assigned to only one of the column group.

15. The LDPC decoder according to claim 1, wherein each of the columns comprises a plurality of rows, each of the submatrices is located in a corresponding one of the rows, each of the submatrices is a zero matrix or a shifted identity matrix, and the zero matrices located in the same row of all of the columns in each of the column groups are merged.
